(19) United States
(12) Patent Application Publication
(10) Pub. No.: US 2023/0085057 A1
(43) Pub. Date: Mar. 16, 2023

(54) MECHANISM FOR ADJUSTING POSITION OF A REMOVABLE FENCE OF A POWER MITER SAW

(71) Applicant: Chin-Chin Chang, Taichung City (TW)

(72) Inventor: Chin-Chin Chang, Taichung City (TW)

(21) Appl. No.: 17/475,722

(22) Filed: Sep. 15, 2021

(51) Int. Cl. B27B 27/10; B27B 27/06

(52) U.S. Cl. CPC B27B 27/10; B27B 27/06

(57) ABSTRACT

A miter saw includes a base including a pivotal turntable; a guide track affixed to one side of the base and including a lengthwise groove and a projection at an end of the lengthwise groove; a stationary fence affixed to the other side of the base; a removable fence on one side of the base, the removable fence aligned with and spaced apart from the stationary fence, the removable fence including a downward projecting, elongated sliding member slidably mounted in the lengthwise groove, a protrusion at an end of the sliding member, the protrusion being adjacent to the projection, a screw hole in the protrusion, and an adjustment screw rotatably disposed in the screw hole and urging against the projection; and a cutting assembly including a rotatable circular saw blade pivotably mounted on the base and disposed between the removable fence and the stationary fence.

### BACKGROUND OF THE INVENTION

### 1. Field of the Invention

The invention relates to power tools and more particularly to a mechanism for adjusting position of a removable fence with respect to a rotatable circular saw blade of a power miter saw so that the rotatable circular saw blade may pivot with respect to the turntable.

### 2. Description of Related Art

U.S. Pat. No. 10,322,459 to the present inventor Chang discloses a power miter saw comprising a base including positioning apertures; a table rotatably mounted on the base and including an arm projecting forward; a saw blade and motor mechanism configured to rotate a circular saw blade thereof; a pivotal positioning seat interconnecting two linear guide mechanisms and a support seat at a rear end of the base; a connecting seat interconnecting the linear guide mechanisms to the saw blade and motor mechanism; a locking device; and a positioning device. Knob rotation and button pressing may adjust a rotational position of the table.

While the device enjoys its success in the market, continuing improvements with respect to a mechanism for adjusting a rotational position of a table of a power miter saw are constantly being sought.

### SUMMARY OF THE INVENTION

It is therefore one object of the invention to provide a miter saw comprising a base including a turntable pivotably mounted thereon; a guide track affixed to one side of the base and including a lengthwise groove and a projection at an end of the lengthwise groove; a stationary fence affixed to the other side of the base; a removable fence on one side of the base, the removable fence aligned with and spaced apart from the stationary fence, the removable fence including a downward projecting, elongated sliding member slidably mounted in the lengthwise groove, a protrusion at an end of the sliding member, the protrusion being adjacent to the projection, a screw hole in the protrusion, and an adjustment screw rotatably disposed in the screw hole and urging against the projection; and a cutting assembly including a rotatable circular saw blade pivotably mounted on the base and disposed between the removable fence and the stationary fence; wherein in response to turning the adjustment screw in a first direction, the adjustment screw moves one of the removable fences away from the rotatable circular saw blade to separate the rotatable circular saw blade from the removable fence by first a distance; and wherein in response to turning the adjustment screw in a second direction opposing the first direction, the adjustment screw moves one of the removable fences toward the rotatable circular saw blade to separate the rotatable circular saw blade from the removable fence by second distance.

The above and other objects, features and advantages of the invention will become apparent from the following detailed description taken with the accompanying drawings.

### BRIEF DESCRIPTION OF THE DRAWINGS

FIG. 1 is a perspective view of a power miter saw incorporating a mechanism for adjusting position of a removable fence according to the invention;

FIG. 2 is another perspective view of FIG. 1;

FIG. 3 is an exploded view of FIG. 1;

FIG. 4 is an exploded view showing the removable fence to be slidably mounted in the guide track;

FIG. 5 is a longitudinal sectional view of the removable fence;

FIG. 5A is a detailed view of the area 5A in FIG. 5;

FIG. 6 schematically depicts the removable fence separated from the rotatable circular saw blade by a first distance S1;

FIG. 6A schematically depicts the removable fence separated from the rotatable circular saw blade by a second distance S1 after the adjustment screw has been manipulated;

FIG. 7 is a detailed view of the area 7 in FIG. 6;

FIG. 7A is a detailed view of the area 7A in FIG. 6A;

FIG. 8 schematically depicts the position of the rotatable circular saw blade relative to the turntable in FIG. 1;

FIG. 9 is a further perspective view of FIG. 1 showing the rotatable circular saw blade has rotated 60 degrees relative to the turntable;

FIG. 10 schematically depicts the removable fence separated from the rotatable circular saw blade by a third distance S1 after the rotatable circular saw blade has rotated 60 degrees relative to the turntable; and

FIG. 10A is a detailed view of the area 10A in FIG. 10.

### DETAILED DESCRIPTION OF THE INVENTION

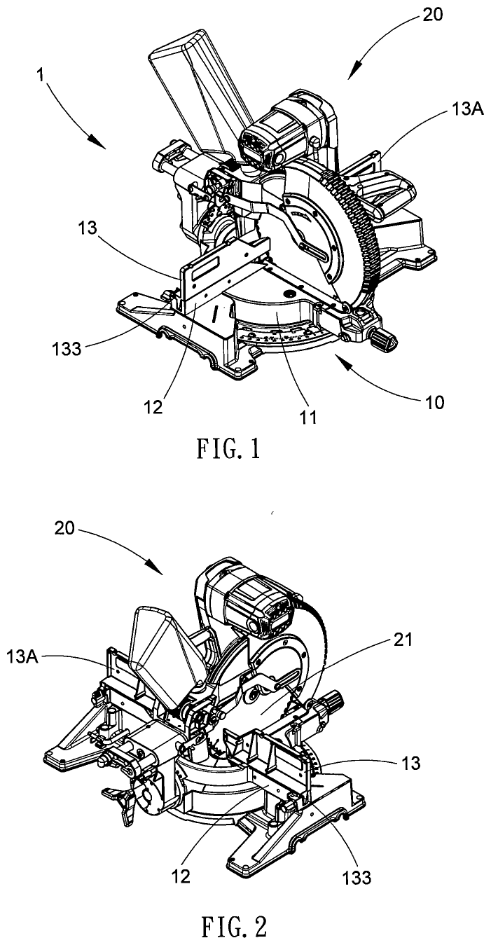

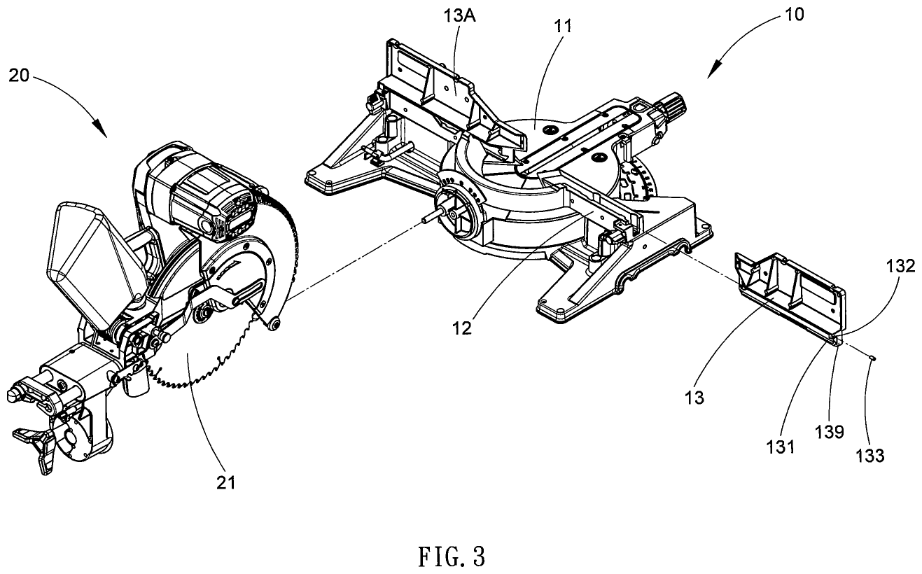

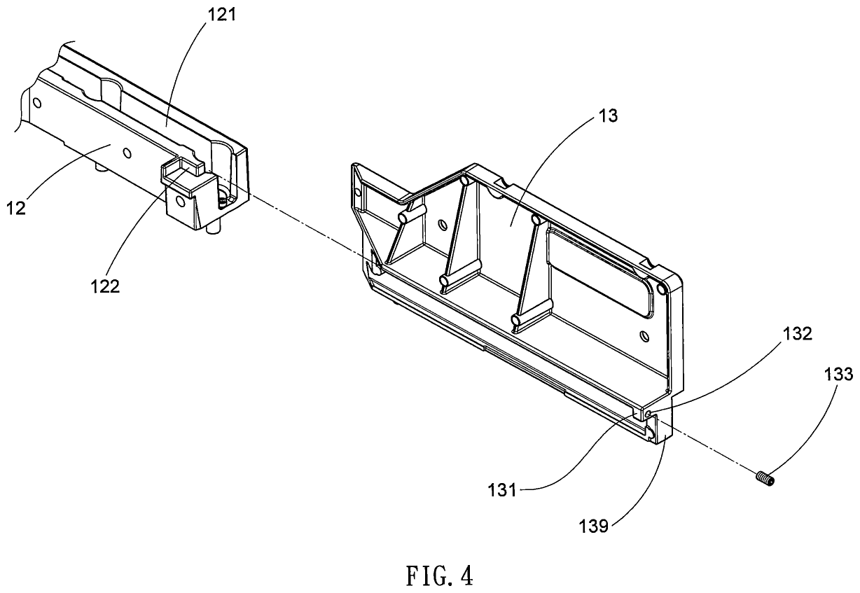

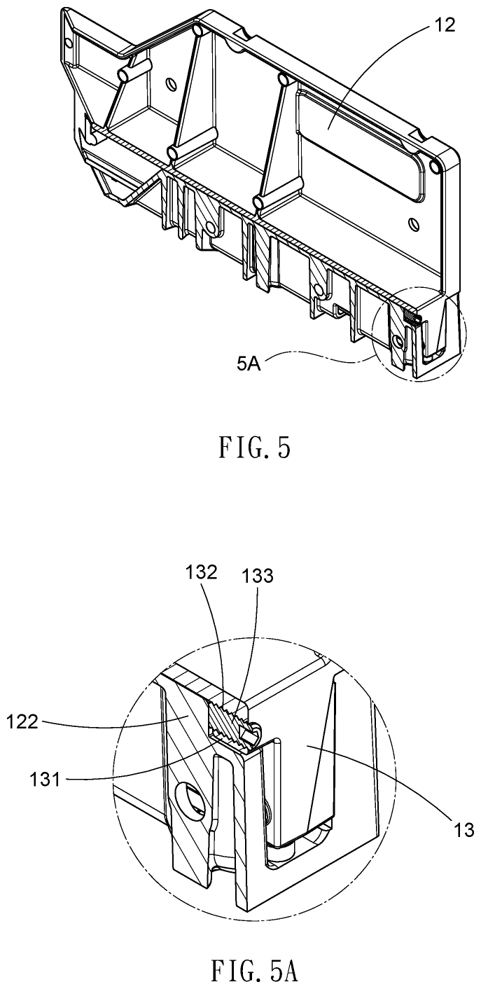

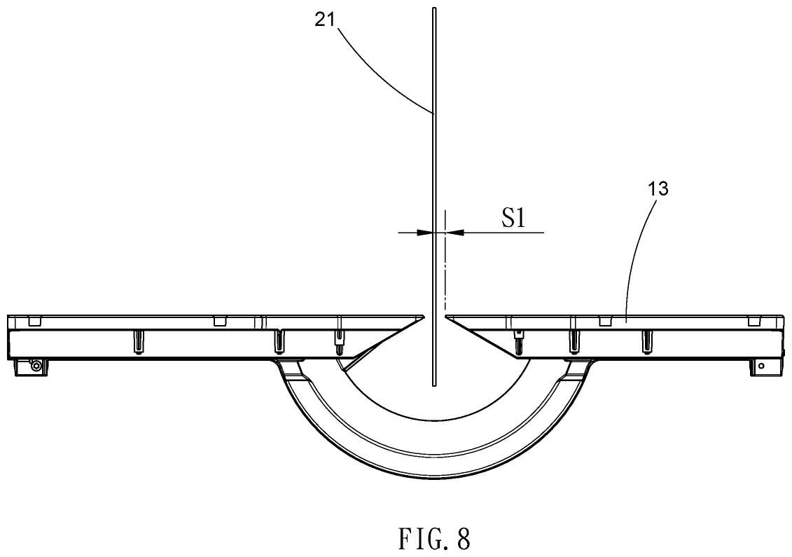

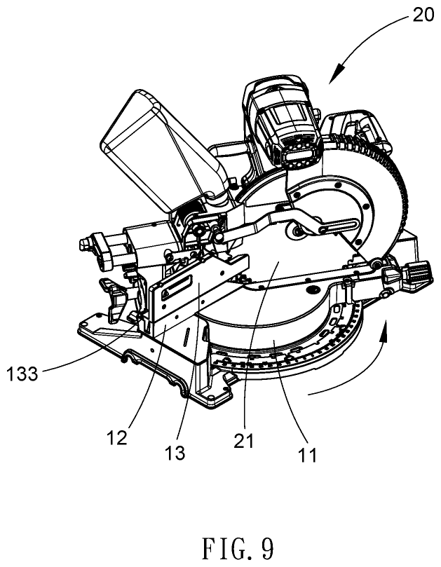

Referring to FIGS. 1 to 10A, a power miter saw 1 in accordance with the invention comprises the following components as discussed in detail below.

A base 10 includes a turntable 11 pivotably mounted thereon and configured to receive a workpiece (not shown); a guide track 12 affixed to one side of the base 10 and including a lengthwise groove 121 and a projection 122 at an end of the groove 121; a stationary fence 13A affixed to the other side of the base 10; a removable fence 13 on one side of the base 10, the removable fence 13 aligned with and spaced apart from the stationary fence 13A, the removable fence 13 including a downward projecting, elongated sliding member 139 slidably mounted in the groove 121, a protrusion 131 at an end of the sliding member 139, the protrusion 131 being adjacent to the projection 122, a screw hole 132 in the protrusion 131, and an adjustment screw 133 rotatably disposed in the screw hole 132. In assembly, a person may push the removable fence 13 inward until the protrusion 131 urges against the projection 122.

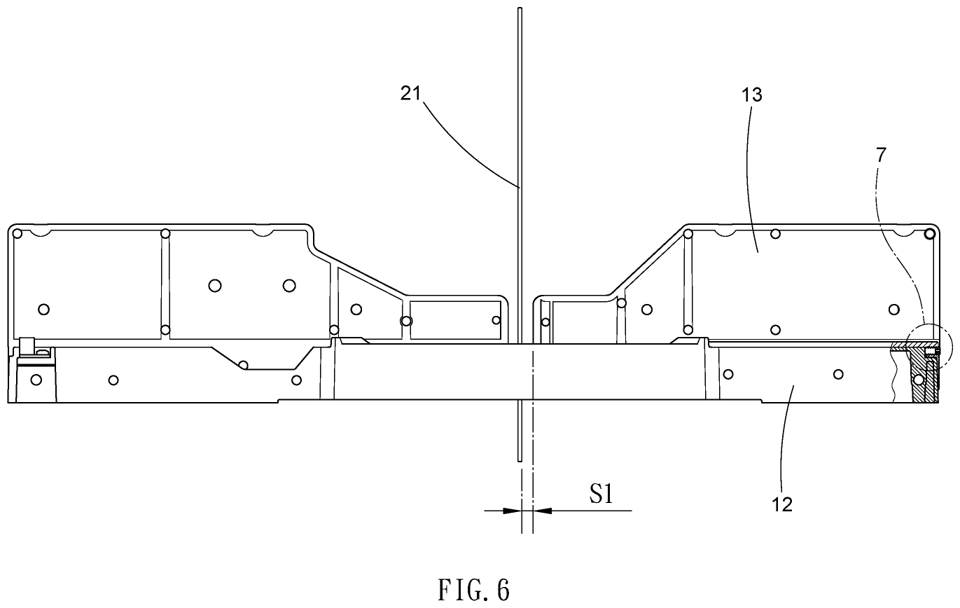

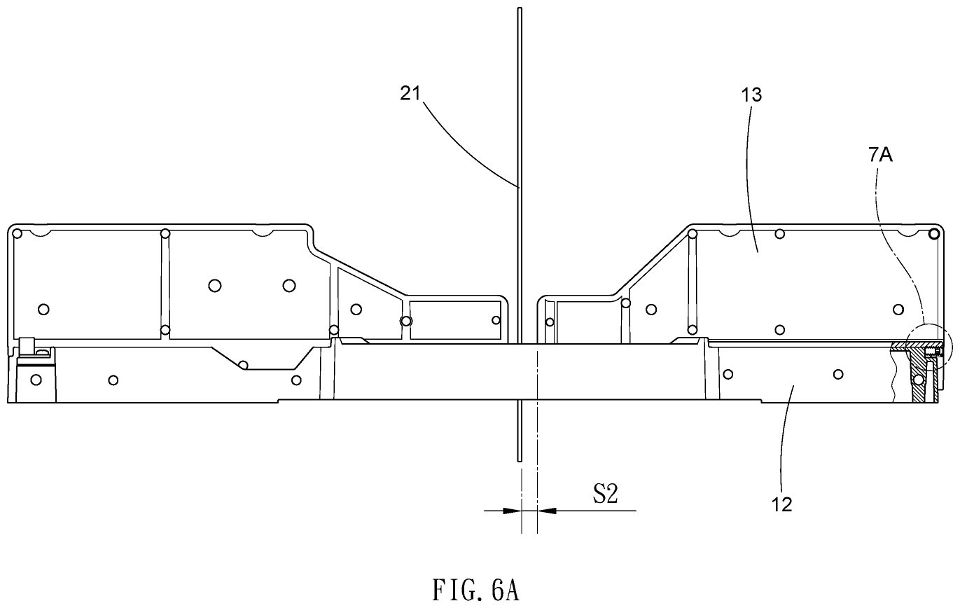

A cutting assembly 20 includes a rotatable circular saw blade 21 pivotably mounted on the base 10 and disposed between the removable fence 13 and the stationary fence 13A. As shown in FIG. 6, the rotatable circular saw blade 21 is separated from the removable fence 13 by a first distance S1.

A mechanism for adjusting a pivotal position of the removable fence 13 with respect to the rotatable circular saw blade 21 as the subject of the invention is discussed in detail below.

In a cutting operation, for adjusting an angle of the rotatable circular saw blade 21 with respect to the turntable 11, the person may counterclockwise turn the adjustment screw 133. And in turn, the adjustment screw 133 moves the removable fence 13 away from the rotatable circular saw blade 21 by pulling the removable fence 13 until a desired distance between the removable fence 13 and the circular saw blade 21 is reached. Thus, the rotatable circular saw blade 21 is separated from the—removable fence 13 by a second distance S2 (see FIG. 6A) which is greater than the first distance S1. Thereafter, the person may pivot the rotatable circular saw blade 21 with respect to the turntable 11 (i.e., base 10). It is noted that the circular saw blade 21 does not contact the removable fence 13 irrespective of its pivotal angle.

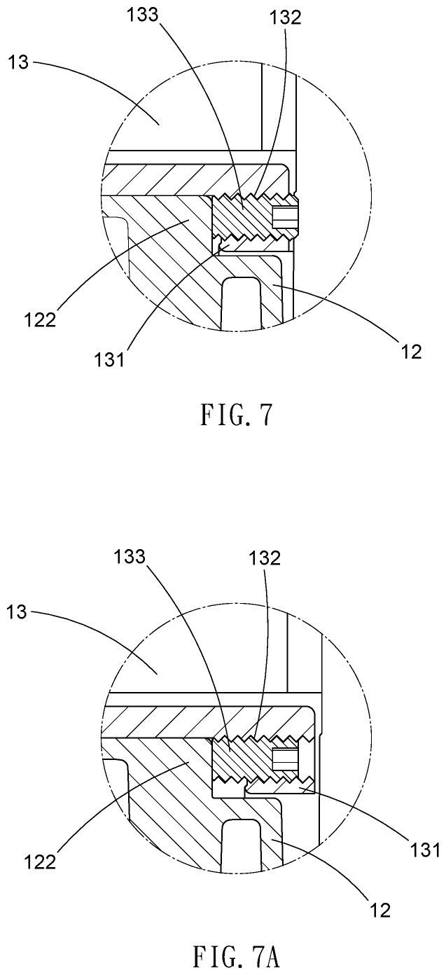

For example, in a distance adjustment operation, the person my clockwise rotate the adjustment screw 133 to move the adjustment screw 133 to the left (i.e., from the position of FIG. 7 to that of FIG. 7A). Thus, a distance between the removable fence 13 and the circular saw blade 21 is increased (FIG. 6A). To the contrary, the person my counterclockwise rotate the adjustment screw 133 to move the adjustment screw 133 to the right (i.e., from the position of FIG. 7A to that of FIG. 7). Thus, the removable fence 13 moves toward the circular saw blade 21. As a result, the distance between the removable fence 13 and the circular saw blade 21 is decreased (FIG. 6).

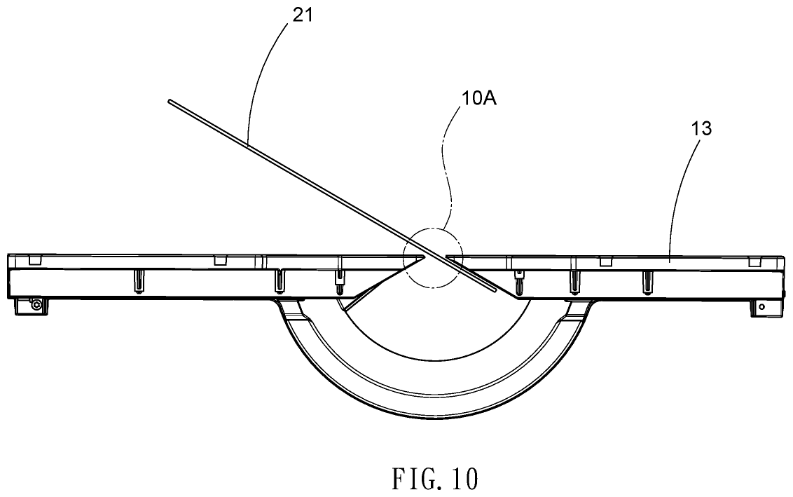

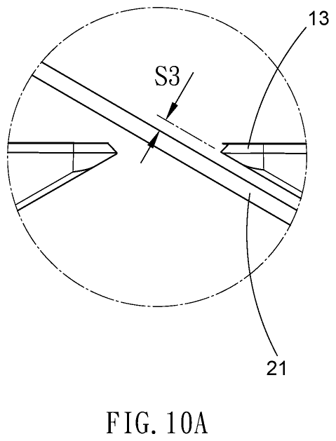

Further, the person my pivot the rotatable circular saw blade 21 about 60 degrees with respect to the base 10. Thus, the rotatable circular saw blade 21 is separated from one removable fence 13 by a third distance S3 (see FIG. 10).

While the invention has been described in terms of preferred embodiments, those skilled in the art will recognize that the invention can be practiced with modifications within the spirit and scope of the appended claims.

1. A miter saw, comprising:
a base including a turntable pivotably mounted thereon;
a guide track affixed to one side of the base and including a lengthwise groove and a projection at an end of the lengthwise groove; a stationary fence affixed to the other side of the base; a removable fence on one side of the base, the removable fence aligned with and spaced apart from the stationary fence, the removable fence including a downward projecting, elongated sliding member slidably mounted in the lengthwise groove, a protrusion at an end of the sliding member, the protrusion being adjacent to the projection, a screw hole in the protrusion, and an adjustment screw rotatably disposed in the screw hole and configured to urge the protrusion against the projection; and
a cutting assembly including a rotatable circular saw blade pivotably mounted on the base and disposed between the removable fence and the stationary fence.
